(19) United States
(12) Patent Application Publication
(10) Pub. No.: US 2005/0018963 A1
(43) Pub. Date: Jan. 27, 2005

(54) Multi-order dispersion compensation device

(76) Inventor: Mark Andrew Englund, New South Wales (AU)

Correspondence Address: LADAS & PARRY LLP, 224 SOUTH MICHIGAN AVENUE, SUITE 1200, CHICAGO, IL, 60604, US

(21) Appl. No.: 10/490,553

(22) PCT Filed: Sep. 24, 2002
(86) PCT No.: PCT/AU02/01311

(30) Foreign Application Priority Data
Sep. 24, 2001 (AU) PR 7860

(51) Int. Cl. G02B 6/34

(52) U.S. Cl. 385/37

(57) ABSTRACT

The present invention provides a multi-order dispersion compensation device comprising a plurality of concatenated dispersion compensation units of different order n. Each of the units comprises at least two chirped Bragg gratings of order n+1 which are concatenated and have opposing group delay profiles.

### FIELD OF THE INVENTION

The present invention relates to a multi-order dispersion compensation device.

### BACKGROUND OF THE INVENTION

Chromatic dispersion is a phenomenon which places limits on the rate of photonic signal transmission in optical waveguides and may be defined as the variation of propagation time as a function of wavelength within a waveguide. Chromatic dispersion increases with the bandwidth of a photonic signal and limits the transmission distance, particularly at high data rates. A known method of partially eliminating chromatic dispersion has been to reflect photonic signals using an optical fibre incorporating a chirped Bragg grating. When a chromatically-dispersed signal enters a chirped grating, the penetration depth of the signal into the grating increases with wavelength, thus producing a wavelength-dependent time delay, referred to as “group delay”. The dispersion of a photonic signal depends on different parameters, one of them is the particular distance over which the signal has been guided in a waveguide. As photonic signal rates increase, the tolerance window for chromatic dispersion compensation decreases. This implies the compensation devices have to be very well matched to the particular optical fibre link in high signal rate systems. Tunable dispersion compensators are thus becoming an area of intense interest.

Fells et al [Fells J A J, Kanellopoulos, S. E., Bennett, P. J., Baker, V., Priddle, H. F. M., Lee, W. S., Collar A. J., Rogers C. B., Goodchild D. P., Feced R., Pugh B. J., Clements S. J., Hadjifotiou A., “Twin fibre grating adjustable dispersion compensator for 40 gbits”, European Conf. Optical Communications, Berlin, Germany, Sept 2000] have described a tunable linear dispersion compensation device comprising two quadratically chirped Bragg gratings that are interconnected in a manner such that their group delay profiles oppose. With linear dispersion compensation in place, higher-order dispersion of the photonic signal can also accumulate over large distances.

### SUMMARY OF THE INVENTION

The present invention provides a multi-order dispersion compensation device comprising
a plurality of concatenated dispersion compensation units of different order n, each of the units comprising at least two chirped Bragg gratings of order n+1 which are concatenated and have opposing group delay profiles and
a control means for independent control of the dispersion compensation of each order which the device is compensating.

The present invention also provides a method of compensating a multi-order dispersion, the method comprising the steps of
providing a pair of concatenated dispersion compensation units of different order n, each of the units comprising at least two chirped Bragg gratings of order n+1 which are concatenated and have opposing group delay profiles,
adjusting the dispersion compensation so that the dispersion compensation of each unit can be controlled independently and
utilizing the dispersion compensation units together to compensate the multi order dispersion.

In a specific embodiment each of the units comprises a first and a second Bragg grating, the first Bragg grating being chirped to provide a group delay φ′ₘ=(φₘ−Sₙ₊₁)ⁿ⁺¹ as a function of wavelength λₘ (sₙ₊₁: refractive index step shift parameter, φₘ: group delay) the second Bragg grating being chirped to provide a group delay φ′ₘ=(φₘ−tₙ₊₁)ⁿ⁺¹ as a function of wavelength λₘ (tₙ₊₁: refractive index shift parameter), the Bragg gratings being concatenated such that their group delay profiles oppose and their reflection spectra interfere substantially constructively.

For example, in a first order dispersion compensation unit (n=1) the group delay provided by the first grating as function of λₘ is φₘ²−(2t₂×φₘ)+t₂² and that of the second grating is φₘ²−(2s₂×φₘ)+s₂². Both gratings are concatenated such that their individual group delays oppose and the resultant group delay of the device is therefore the difference between the group delays provided by both gratings and equal to (2s₂−2t₂)×φₘ+(t₂²−s₂²). Since φₘ is directly related to the wavelength λₘ, the dispersion compensation unit has a first order (linear) dependency on the wavelength and the parameters s and t control the group delay as function of wavelength. The unit may be used for both negative or positive dispersion compensation which offers additional flexibility.

In case of a second order (n=2) dispersion compensation unit, for example, the first Bragg grating is chirped to provide a group delay of φ′ₘ=(φₘ−s₃)³ and a second Bragg grating is chirped to provide a group delay of φ′ₘ=(φₘ−t₃)³. The unit will, when in use, provide a group delay of (3t₃−3s₃)×φₘ²+(3s₃²−et₃²)×φₘ=31 s₃³+t₃³. The quadratic dispersion compensation is therefore controllable by the term (3t₃−3s₃) and the linear dispersion is controllable by the term (3s₃²−3t₃²). Both terms are, however, dependent on each other and the quadratic dispersion compensation cannot be changed without changing the linear dispersion compensation. If, however, the second order dispersion compensation unit is concatenated with a first order dispersion compensation unit to form a first and second order dispersion compensation device, an additional parameter is available to control the linear dispersion compensation and therefore linear and quadratic dispersion can be controlled independently. In an analogous manner the dispersion compensation of the device comprising additional third, fourth etc. order dispersion compensation units can be controlled independently form each other.

The dispersion compensation device typically comprises a first order and a second order dispersion compensation unit.

The device may comprise means for effecting the position of at least one grating by heating or cooling and/or by the application of mechanical stress.

At least one of the parameters sₙ₊₁ or tₙ₊₁ may be equal to zero. The device may also comprise means for adjusting at least one of the parameters sₙ₊₁ or tₙ₊₁ by applying mechanical stress to the gratings. Alternatively, or additionally, the device may comprise means for effectively adjusting at least one of the parameters sₙ₊₁ or tₙ₊₁ by heating or cooling the Bragg gratings. Owing to the thermo-optic effect, heating or cooling of the gratings changes their effective refractive index and therefore their effective periods.

At least one of the first or/and the second grating typically is apodized. In a specific embodiment all of the first and the second gratings are apodized.

The above-defined method typically comprises the step of adjusting the higher-order unit and thereafter compensating the resultant effect on the lower order dispersion compensation by adjusting the dispersion compensation of the lower order unit. Each dispersion compensation unit in the pair of units may be one of a plurality of units.

The invention may be more fully understood from the following background information and the description of a specific embodiment, by way of example only. The description is provided with reference to the accompanying drawings.

### BRIEF DESCRIPTION OF THE DRAWINGS

FIG. 1 shows a diagrammatic representation of a specific embodiment of the dispersion compensation device,

FIG. 2 shows a diagrammatic representation of a dispersion compensation unit,

FIG. 3 shows group delay versus wavelength plots for the first and second Bragg gratings of the unit, and

FIG. 4 shows group delay versus wavelength plots for the unit.

### DETAILED DESCRIPTION OF A SPECIFIC EMBODIMENT

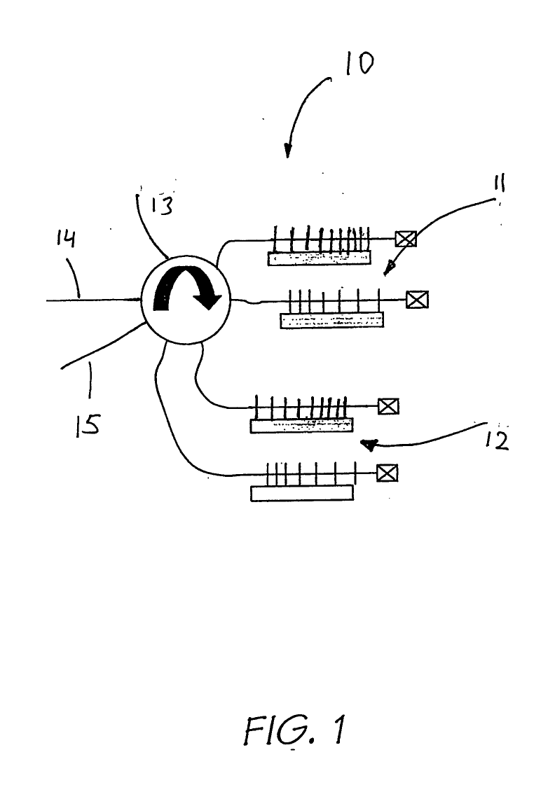

FIG. 1 shows a diagrammatic representation of an embodiment of the dispersion compensation device 10 which allows the independent control of first and second order dispersion compensation. A first order dispersion compensation unit 11 and a second order dispersion compensation unit 12 are concatenated by a circulator 13. The device 10 has an input 14 and an output 15. In use, the dispersion compensation of the second unit may initially be adjusted which also has an effect on the first order dispersion compensation of the device. The first order unit may then be employed to compensate for this effect and to adjust the first order dispersion compensation of the device to meet requirements.

It will be appreciated that the invention is not restricted to a device comprising first and second order units but the device may also comprise a plurality of additional higher order dispersion compensation units. The following will describe how the dispersion compensation units function. This is by way of example, showing one dispersion compensation unit only.

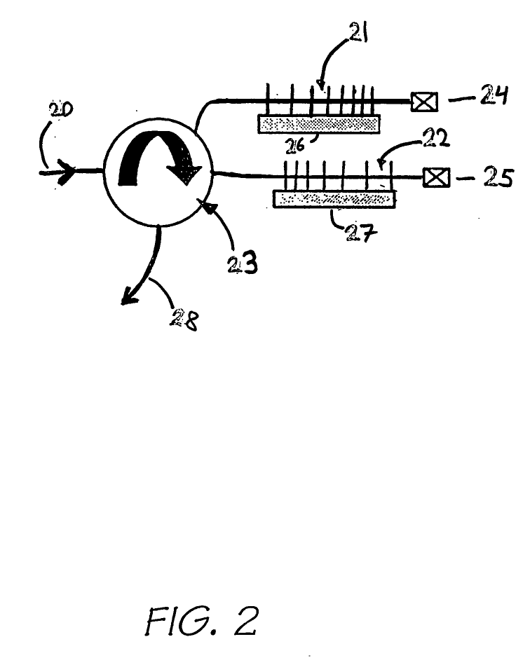

FIG. 2 shows an embodiment of the dispersion compensation unit in which a waveguide 20 functions to guide a photonic signal. In this example the unit is a first order unit and comprises two quadratically chirped Bragg gratings 21 and 22 which are concatenated by an optical circulator 23. The optical paths are terminated by waveguide terminators 24 and 25. Both Bragg gratings are mounted onto Peltier devices, 26 and 27, designed to heat or cool the Bragg gratings. They are also mounted with facility to apply mechanical stress to them. The output signal is, in use, output to waveguide 28. The Bragg gratings are aligned such that their reflection spectra interfere constructively.

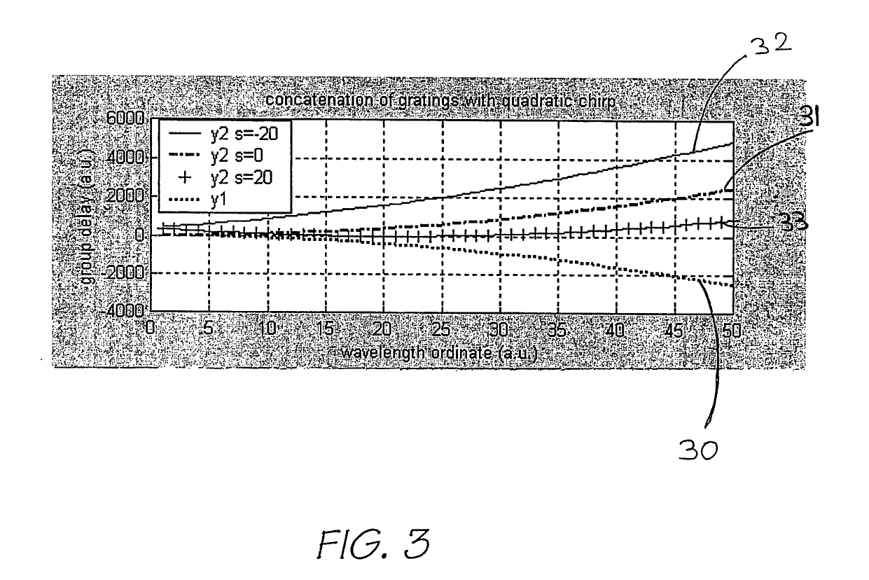

FIG. 3 shows examples of group delay versus wavelength plots (in arbitrary units, a.u.). Plot 30 and 31 show the group delay of the first Bragg grating and the second Bragg grating respectively. Plot 32 shows the calculated group delay for the second grating that has been strained to effect a group delay off-set of −20 a.u. and plot 33 shows the calculated group delay for the second Bragg grating that has been strained to effect a group delay off-set of 20 a.u.

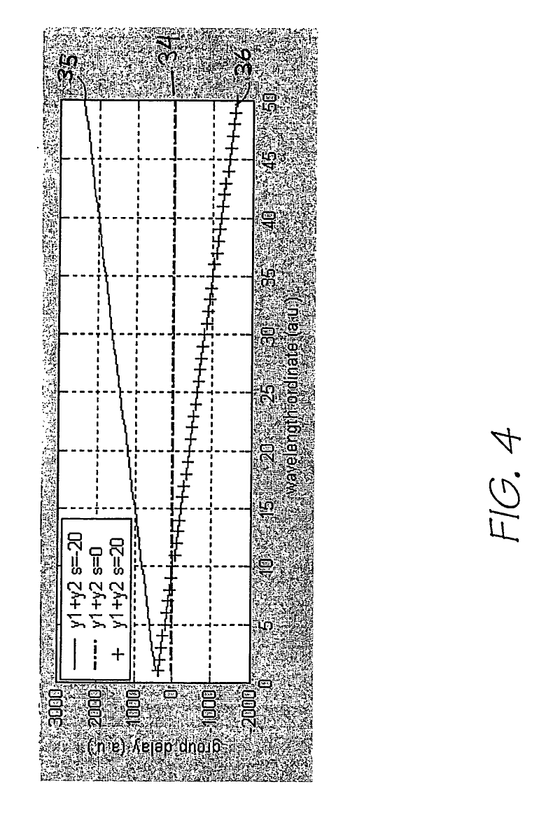

FIG. 4 shows the resultant group delay of the unit. If both Bragg gratings are at their original positions, the group delays cancel (plot 34). After straining the second Bragg grating (−20 a.u.) the resultant group delay is linear and the gradient negative (plot 35). After straining the second Bragg grating to effect a group delay off-set of 20 a.u., the resultant group delay of the device is also linear and the gradient positive (plot 36). It will be appreciated that the application of different strains to the gratings results in different gradients and the group delay of the device can be adjusted to meet specific requirements. In an alternative example the unit may comprise two higher order gratings, such as 3^{rd} order, which are concatenated in analogous manner and which form a unit that allows the control of second order dispersion compensation.

Although the embodiment has been described with reference to particular examples, it will be appreciated by those skilled in the art that the invention may be embodied in many other forms. For example, more than two dispersion compensation units of different orders may be concatenated to form the device. They may be arranged such that the dispersion compensation of the different orders is independently controllable. The device may be connected to any length of an optical transmission line and may be arranged for the compensation of dispersion that light suffered when transmitted though the transmission line.

It is to be understood that, if any prior art publication is referred to herein, such reference does not constitute an admission that the publication forms a part of the common general knowledge in the art, in Australia or any other country.

1. A multi-order dispersion compensation device comprising:
a plurality of concatenated dispersion compensation units of different order n, each of the units comprising at least two chirped Bragg gratings of order n+1 which are concatenated and have opposing group delay profiles and
a control means for independent control of the dispersion compensation of each order which the device is compensating.

2. The multi-order dispersion compensation device as claimed in claims 1 wherein each unit of order n comprises a first and a second Bragg grating, the first Bragg grating being chirped to provide a group delay φ′ₘ=(φₘ−sₙ₊₁)ⁿ⁺¹ as a function of wavelength λₘ (sₙ₊₁: refractive index step shift parameter) the second Bragg grating being chirped to provide a group delay (φₘ−tₙ₊₁)ⁿ⁺¹ as a function of wavelength λₘ (tₙ₊₁: refractive index step shift parameter), the Bragg gratings being concatenated such that their group delay profiles oppose and their reflection spectra interfere substantially constructively.

3. The multi-order dispersion compensation device as claimed in claim 1 comprising a first order and a second order dispersion compensation unit.

4. The multi-order dispersion compensation device as claimed in claim 1 wherein the control means is arranged for effecting the position of at least one of the first and second Bragg grating by heating or cooling.

5. The multi-order dispersion compensation device as claimed in claim 1 wherein the control means is arranged for effecting the position of at least one of the first and second Bragg grating by the application of mechanical stress.

6. The multi-order dispersion compensation device as claimed in claim 1 wherein at least one of the parameters tₙ₊₁ or sₙ₊₁ is equal to zero.

7. The multi-order dispersion compensation device as claimed in claim 1 wherein the control means is arranged for adjusting at least one of the parameters sₙ₊₁ or tₙ₊₁ by applying mechanical stress to the or each respective Bragg grating.

8. The multi-order dispersion compensation device as claimed in claim 1 wherein the control means is arranged for effectively adjusting at least one of the parameters sₙ₊₁ or tₙ₊₁ by heating or cooling the or each respective Bragg grating.

9. The multi-order dispersion compensation device as claimed in claim 1 wherein at least one of the first and/or the second Bragg grating is apodized.

10. The multi-order dispersion compensation device as claimed in claim 1 wherein all of the first and the second Bragg gratings are apodized.

11. A method of compensating a multi-order dispersion, the method comprising the steps of:
providing a pair of concatenated dispersion compensation units of different order n, each of the units comprising at least two chirped Bragg gratings of order n+1 which are concatenated and have opposing group delay profiles,
adjusting the dispersion compensation so that the dispersion compensation of each unit can be controlled independently and
utilizing the dispersion compensation units together to compensate the multi order dispersion.

12. The method as claimed in claim 11 comprising the steps of adjusting the higher-order unit and thereafter compensating the resultant effect on the lower order dispersion compensation by adjusting the dispersion compensation of the lower order unit.

13. The method as claimed in claim 11 wherein each dispersion compensation unit in the pair of units is one of a plurality of units.
